(19) United States
(12) Patent Application Publication
(10) Pub. No.: US 2006/0227907 A1
(43) Pub. Date: Oct. 12, 2006

(54) Broadcasting receiver

(75) Inventor: Doo-Roo Lim, Seoul (KR)

Correspondence Address: VENABLE LLP, P.O. BOX 34385, WASHINGTON, DC, 20045-9998, US

(73) Assignee: Ace Antenna Corp., Incheon (KR)

(21) Appl. No.: 11/399,533

(22) Filed: Apr. 7, 2006

(30) Foreign Application Priority Data
Apr. 12, 2005 (KR) 10-2005-0030447

(51) Int. Cl. H04L 27/08

(52) U.S. Cl. 375/345

(57) ABSTRACT

Provided is a digital broadcasting receiver that converts received signals including broadcasting signals of all channels directly to digital ones and then processes them, without change of intermediate frequency thereof. The inventive broadcasting receiver comprises an antenna for receiving signals of entire broadcasting bands on which broadcasting channels exist, a digital conversion module that includes a Variable Gain Amplifier (VGA) module for sampling the received signals from the antenna at sampling frequencies with no aliasing and amplifying the signals, an analog to digital conversion module for sampling the output signals from the VGA module to convert them to digital received digitals and a power detector module for detecting powers of the digital received signals to apply them to a gain value of the VGA module, and a digital processing module for extracting only a signal of desired channel from the output signals of the digital conversion module. The broadcasting receiver of the invention can save a manufacturing cost and also can efficiently use its overall implementation space by making a channel selection by a digital process without using an analog tuner.

### FIELD OF THE INVENTION

The present invention relates to a broadcasting receiver employing a digital conversion technique; and, more particularly, to a digital broadcasting receiver that converts received signals including broadcasting signals of all channels directly to digital ones and then processes them, without change of intermediate frequency thereof.

### DESCRIPTION OF RELATED ART

FIG. 1 illustrates a conventional digital broadcasting receiver that is implemented to receive broadcasting waves such as AM and/or FM radio waves. As shown therein, the prior art broadcasting receiver utilizes a tuner 120 to receive desired frequency waves. Such a tuner serves to extract only broadcasting waves of desired frequency and convert the same to an intermediate frequency, and also to remove a signal excluding a preset band through a band pass filter.

The intermediate frequency signal converted by the tuner 120 is converted to a digital signal by an Analog to Digital Converter (ADC) 130; and then delivered to a Digital Down Converter (DDC) 140 for a digital signal processing required.

Since, however, the conventional digital broadcasting receiver as structured above conducts the channel selection and intermediate frequency conversion at the analog signal stage, it needs a gigantic space due to use of analog devices of relatively large volume. Especially, the above problem increases more and more owing to the tuner of large volume that functions to select a desired channel.

Moreover, there may be involved noise in the process of intermediate frequency conversion that is made at the analog stage. However, the prior art receiver presents no idea to improve such noise problem.

### SUMMARY OF THE INVENTION

It is, therefore, a primary object of the present invention to provide a broadcasting receiver capable of reducing a space and/or a manufacturing cost.

Another object of the present invention is to offer a broadcasting receiver capable of providing a superior quality of received signal.

In accordance with the present invention, there is provided a broadcasting receiver comprising: an antenna for receiving signals of entire broadcasting bands on which broadcasting channels exist; a digital conversion module for sampling the received signals from the antenna at sampling frequencies with no aliasing; and a digital processing module for extracting a signal of desired channel from the output signals of the digital conversion module.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram of a conventional digital broadcasting receiver;

FIG. 2 is a block diagram of a digital broadcasting receiver in accordance with an embodiment of the present invention;

FIGS. 3a to 3c are block diagrams illustrating embodiments of the filter module used in the present invention;

FIGS. 4a to 4c are block diagrams illustrating embodiments of the digital conversion module utilized in the present invention; and

FIGS. 5a to 5e are block diagrams illustrating embodiments of the digital processing module employed in the present invention.

### DETAILED DESCRIPTION OF THE INVENTION

Hereinafter, a preferred embodiment of the present invention will be set forth in detail with reference to the accompanying drawings. First, it should be noted that the terms and words used in this specification and claims should be interpreted as meanings and concepts which coincide with the technical spirit of the invention under the principle that the inventor(s) may properly define the concept of the terms to explain his/her own invention in the best manner, without limiting to general or dictionary meanings. Accordingly, the embodiments disclosed herein and structures shown in the drawings are merely the most preferred embodiments of the present invention, not teaching all of the technical spirit of the present invention. Therefore, those in the art will appreciate that various modifications, substitutions and equivalences may be made, without departing from the scope and spirit of the invention as defined in the accompanying claims.

### Embodiment 1

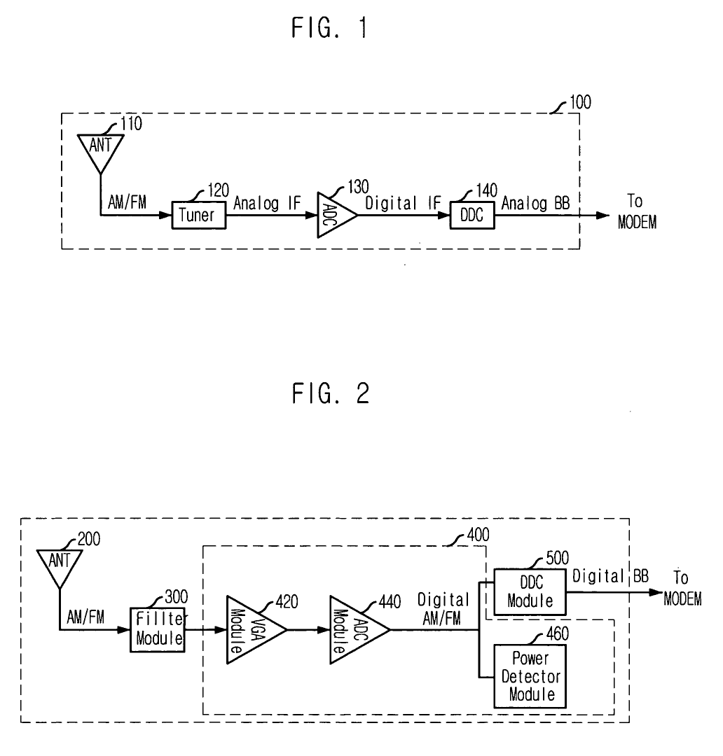

A broadcasting receiver of this embodiment as shown in FIG. 2 comprises an antenna (ANT) 200 for receiving signals of entire broadcasting bands on which broadcasting channels exist, a digital conversion module 400 that includes a Variable Gain Amplifier (VGA) module 420 for sampling the received signals from the ANT 200 at sampling frequencies of more than twice to quadruple of the bandwidth of the signals not to occur any aliasing and amplifying the signals, an ADC module 440 for sampling the output signals from the VGA module 420 to convert them to digital received digitals and a power detector module 460 for detecting powers of the digital received signals to apply them to a gain value of the VGA module 420, and a digital processing (DDC) module 500 for extracting only a signal of desired channel from the output signals of the digital conversion module 400.

Specifically, the ANT 200 as shown may be implemented by a general antenna to receive broadcasting signals and must have an excellent reception characteristic for entire reception bands including all of receivable broadcasting channels at the receiver. For example, in an FM/AM broadcasting receiver, it is preferable to implement by a single antenna with a good resonance characteristic for both of FM and AM broadcasting bands for cost and space reduction, but may be provided with separate antennas suitable for each of FM and AM bands for more superior reception, where necessary.

The ADC module 440 is to convert an analog type received signal amplified by the VGA module 420 to a digital signal. Generally, it is known that a higher sampling frequency causes a high reception quality. But, the ADC module may be implemented by an ADC with an appropriate sampling frequency in consideration with a cost. More specifically, it may be implemented that the sampling frequency of the ADC module 440 is always fixed to one preset frequency or adjusted to a proper value upon its use by measuring a power of received band signal and/or a power of non-received band noise. The sampling frequency should be at least more than the twice of band frequency to be received, and at least more than the quadruple of the band frequency under high noise environment. Therefore, in the fixation way of the sampling frequency, it is preferable to fix the sampling frequency to a larger value than the quadruple of the maximum frequency of the entire broadcasting bands. In any case of the fixation way or adjustment way, the sampling frequency always has a greater value than the twice of the minimum frequency of the entire broadcasting bands. Meanwhile, in case where the entire broadcasting bands are divided into a plurality of subbands as in AM/FM, it may be implemented in such a manner that the sampling frequency is fixed to a larger value than the quadruple of the maximum frequency of each subband every subband. This embodiment is a digital way receiver; and thus, a processor capable of performing an operation function is used therefor. Therefore, it may be implemented that the processor determines a proper sampling frequency based on the power value of the received band signal and/or the power value of the non-received band noise in the adjustment way implementation.

The VGA module 420 used herein is an amplifier that allows a gain value to be variably decided in response to a certain gain control signal, and amplifies the received signal from the ANT 200. Upon amplification, the gain value is adjusted depending on the gain control signal that is feedbacked from the power detector module 460. The reason why the VGA module 420 is used is to prevent a signal of the ADC module 440 from being overflowed or underflowed by maintaining the power level of the input signal to the ADC module to a constant level. As shown, the structure that measures the power of the output signal from the ADC module 460 and feedback-controls the VGA module 420 is easy and inexpensive for its implementation. Alternatively, it may be implemented such that the power of the output signal from the VGA 420 is measured and then the gain value of the VGA module 420 is feedback-controlled, where necessary. And also, it may be embodied that the power of the output signal sent from the digital processing module 500 to a modem is measured and then the gain value of the VGA module 420 is feedback-controlled.

The digital processing module 500 frequency-converts a signal of desired channel out of digital received signals (digital AM/FM signals) including signals of all receivable channels to a baseband signal (generally, called “down conversion”), and removes a signal excluding the desired channel signal using a channel selection filter. In addition, it may also perform the role of adjusting the selected signal to a power level adapted to the modem.

The broadcasting receiver of this embodiment comprises, as the essential elements, the ANT 200, the digital conversion module 400 that includes the VGA module 420 and the ADC module 440, the power detector module 460, and the digital processing module 500. However, it may further comprise other elements where necessary; and the essential elements may be implemented in various structures. Hereinafter, there will be introduced a variety of modified examples of additional constructional elements and the essential elements of this embodiment.

In actual, the ANT 200 takes not only signals of entire bands to be received but also signals of other bands. In this case, there may be occurred aliasing. The aliasing refers to a phenomenon that some of signals of different bands are mixed up in the course of converting analog signal to digital signal. This phenomenon is aggravated when sampling frequency is not sufficiently greater than a frequency of desired band. It is preferable to filter an analog signal by a needed band before its conversion to a digital signal in order to prevent the aliasing phenomenon. For the above purpose, the receiver may be provided with a filter module 300.

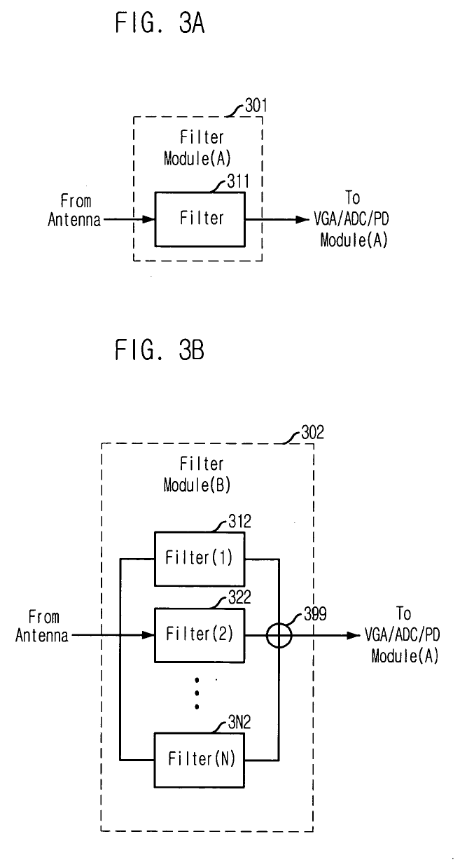

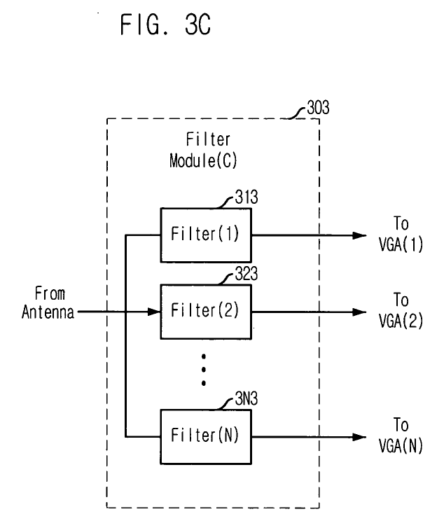

For instance, if a sampling frequency (rate) of the ADC module 440 to be used in sampling is sufficiently higher than a bandwidth of signal, it may be ample to prevent the aliasing although only one filter is employed as shown in FIG. 3a. Meanwhile, if the sampling frequency is not sufficiently higher than the bandwidth or it needs to more improve SNR, separate filters may be used for each of a plurality of divided frequency bands. For example, the filter module may be composed of a structure that has a first filter for AM band, a second filter for FM band and a third filter for DMB broadcasting band, etc. Embodiments of the filter module 300 for the purpose are illustrated in FIGS. 3b and 3c. The filter module as shown in FIG. 3b includes a plurality of filters 312, 322, . . . , 3N2 that take charge of a plurality of divided frequency bands, respectively, and a signal combiner 399 for combining signals filtered for each of the plurality of divided frequency bands to obtain a combined signal. On the other hand, the filter module as shown in FIG. 3c includes a plurality of filters 313, 323, . . . , 3N3 that take charge of a plurality of divided frequency bands, respectively, to provide their outputs to respective output lines, wherein it needs no signal combiner to combine signals after filtering.

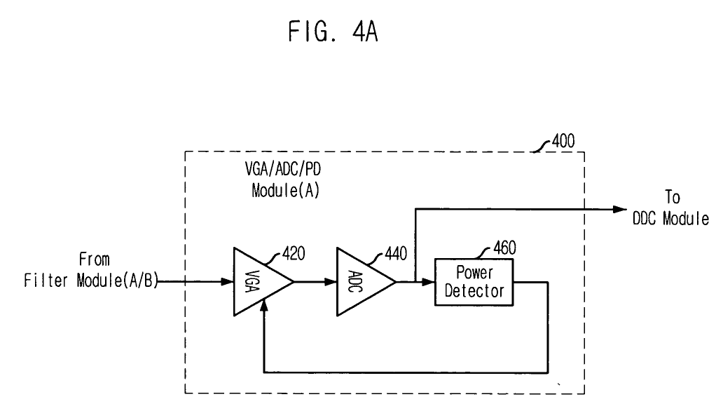

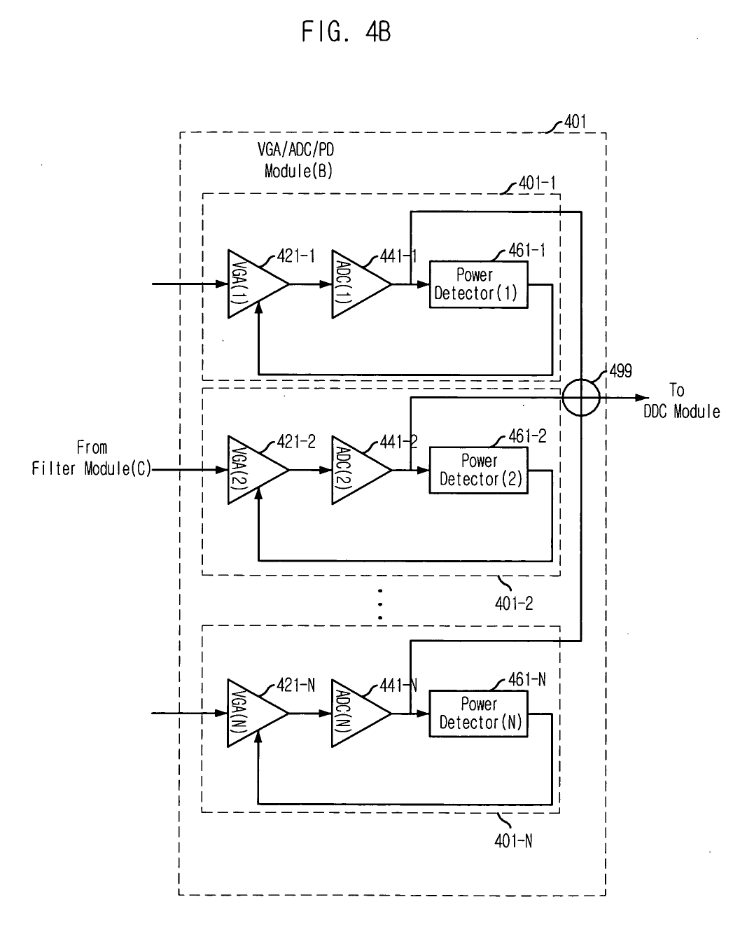

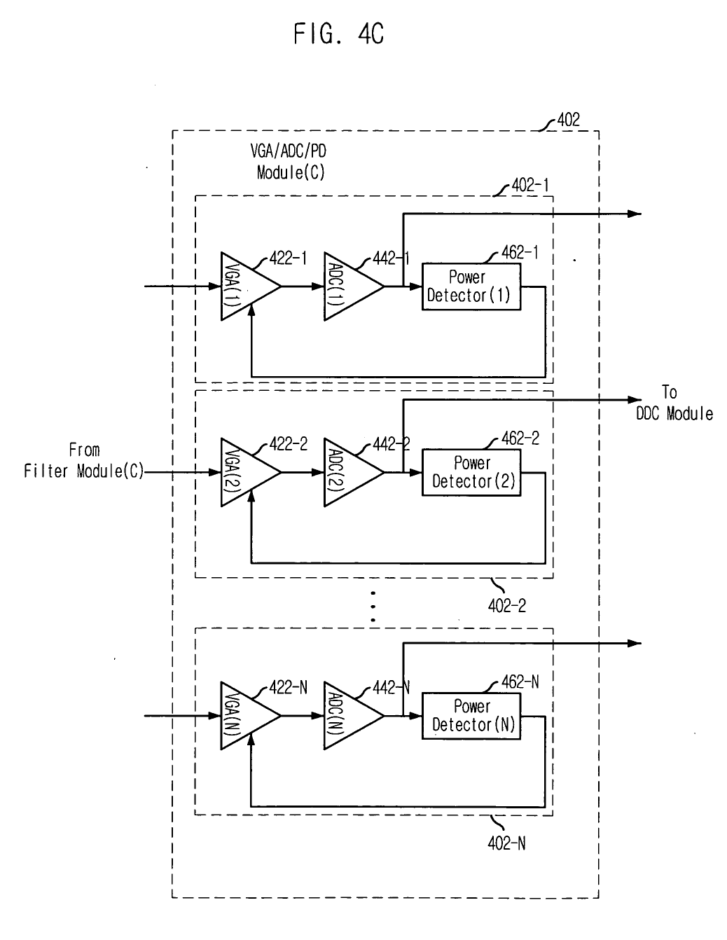

FIGS. 4a and 4b illustrate embodiments of the digital conversion module 400. The digital conversion module 400 as shown in FIG. 4a may be configured to couple with the filter module of FIG. 3a or 3b, and includes the VGA 420, the ADC 440 and the power detector 460, as illustrated in FIG. 2. Meanwhile, the digital conversion module 401 of FIG. 4b is composed of a plurality of digital conversion submodules 401-1 to 401-N, which receive the analog type received signals filtered by the filter module 303 of FIG. 3c for each of the plurality of divided frequency bands, and perform their digital conversions, each of which includes a VGA, an ADC and a power detector. In addition, it further includes a signal combiner 499 for combining the output signals from each of the plurality of digital conversion submodules 401-1 to 401-N to output a combined signal.

And also, although not shown, the power detector contained in the digital conversion module of this embodiment as described early may be implemented that it receives the output signal directly from the VGA and again feedback-controls the gain value thereof. This structure may be easily modified and applied to both of FIGS. 4a and 4b.

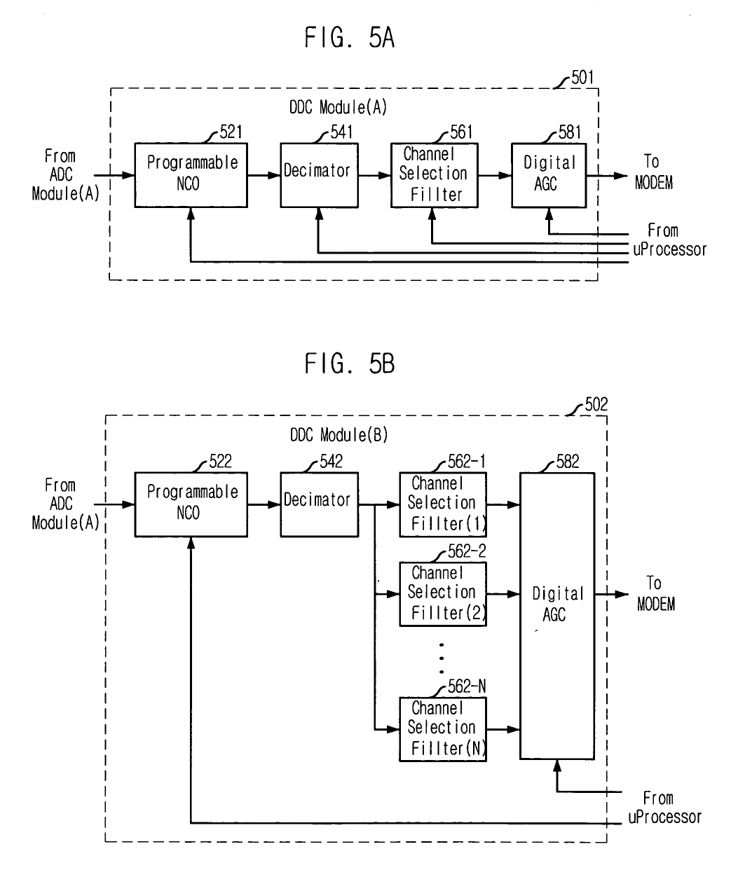

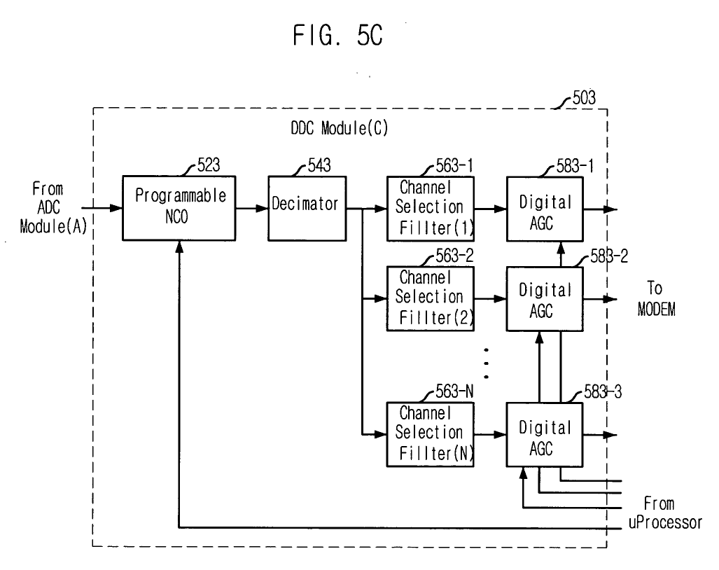

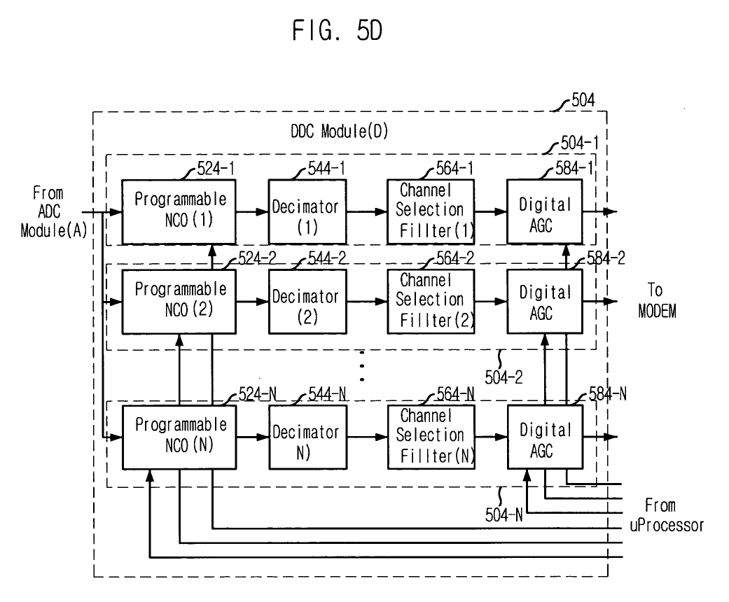

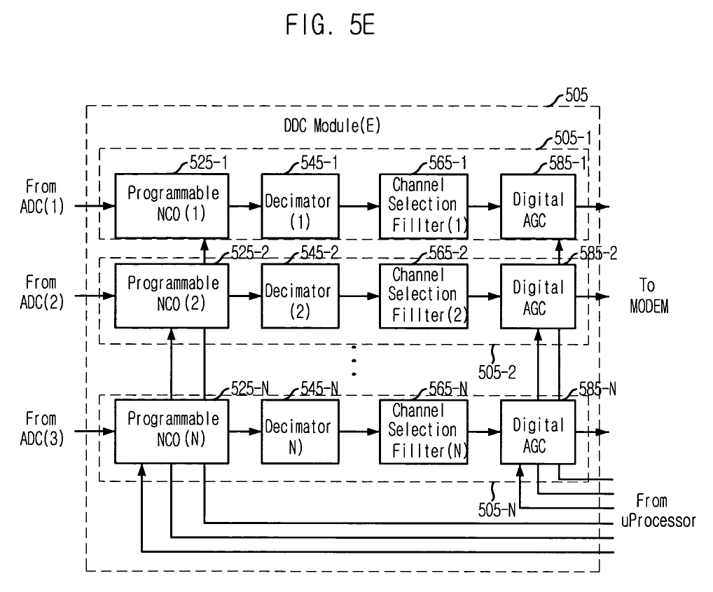

FIGS. 5a to 5d show each embodiment of the digital processing module 500, which can be connected to the digital conversion module 400 of FIG. 4a or 4b.

The digital conversion module 501 of FIG. 5a may be implemented by including a programmable Numerically Controlled Oscillator (NCO) 521, a decimator 541, a channel selection filter 561 and a digital Automatic Gain Controller (AGC) 581. The programmable NCO 521 down-converts a digital broadcasting signal of a preset band frequency to a baseband signal. The decimator 541 serves to reduce a data rate highly sampled compared to a bandwidth of signal to a proper data rate. The channel selection filter 561 removes signals of remaining bands excluding desired broadcasting band. The channel selection that is made in the conventional tuner in a series of processes as above is now performed in the digital processing module 501 of this embodiment. The digital AGC 581 controls the output level of the channel selection filter 561 to make a level suitable for the modem. The channel selection operation in the digital processing module 500 shown in FIG. 5a is made by adjusting the frequency band of the programmable NCO 521 under the control of a processor (uProcessor) that controls the channel selection and modifying coefficient of the channel selection filter 561 based on the received signal.

The digital conversion module 502 of FIG. 5b shows an example that implements by using N separate channel selection filters 562-1 to 562-N to remove delay time caused by new loading of the channel selection filter coefficient when modifying the coefficient of the channel selection filter based on the received signal. FIG. 5c shows an example of channel selection filters 563-1 to 563-N that are implemented by the N separate modules as in FIG. 5b, together with digital AGCs 583-1 to 583-N that are also embodied with N separate modules. The channel selection operation in the digital processing module 502 or 503 shown in FIG. 5b or 5c is made by adjusting the frequency band of the programmable NCO 521 under the control of the processor (uProcessor) that controls the channel selection and selecting one of N channel selection filter modules 562-1 to 562-N or 563-1 to 563-N based on the received signal.

The digital conversion module 504 of FIG. 5d is of a structure that can simultaneously receive one or more broadcastings from the combined signals by using N separate programmable NCOs, N decimators, N channel selection filters and N digital AGCs. Namely, the module 504 is comprised of N digital conversion submodules 504-1 to 504-N, each submodule including a separate programmable NCO, a decimator, a channel selection filter and a digital AGC. The channel selection operation is made by selecting a proper channel selection filter module under the control of the processor (uProcessor) that controls the channel selection.

### Embodiment 2

A broadcasting receiver of this embodiment comprises the filter module 303 of the structure as shown in FIG. 3c that takes the received signal from the ANT, the digital conversion module 402 of the structure as shown in FIG. 4c that receives the N output signals from the filter module 303, and the digital processing module of the structure in FIG. 5e that gets the N output signals from the digital conversion module 402.

The operation principle of each of submodules of the band filters 313, . . . , VGAs 422-1, . . . , ADCs 442-1, . . . , power detectors 462-1, . . . , programmable NCOs 525-1, . . . , decimator 545-1, channel selection filter 565-1, digital AGC 585-1, which constitute this embodiment, is similar to that of the first embodiment as described above. Therefore, a detailed description thereof will be omitted since it may be obviously understood from the description of the first embodiment.

The broadcasting receiver of this embodiment is composed of N submodules of the structure that is similar to the overall receiver structure shown in FIG. 2. The channel selection operation therein is made by selecting a proper broadcasting receiver submodule under the control of a processor (uProcessor) that controls the channel selection. In the structure that is made like the above drawings, although the receiver is implemented that the single antenna receives the broadcasting signals for all of the subbands, it may be provided with separate antennas suitable for respective subbands (for example, FM, AM, and DMB bands) for more superior reception, where necessary.

In addition, in case where the receiver submodules are assigned depending on types of broadcastings, for example, a first submodule is assigned to AM broadcasting band, a second submodule is assigned to FM broadcasting band, a third submodule is assigned to DMB broadcasting band, it is possible to get a suitable quality when the sampling frequency of ADC included in each submodule is more than the twice to quadruple of bandwidth of signal, which occurs no aliasing, as in the first embodiment.

As a result, the broadcasting receiver of the present invention can save a manufacturing cost and also can efficiently use its overall implementation space by making a channel selection by a digital process without using an analog tuner.

Moreover, the present invention has an advantage that it can provide a superior quality of received signal while reducing the overall volume of the receiver by preventing an aliasing using a proper filter, prior to performing an analog to digital conversion.

The present application contains subject matter related to Korean patent application No. 2005-0030447, filed with the Korean Intellectual Property Office on Apr. 12, 2005, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A broadcasting receiver comprising:
an antenna for receiving signals of entire broadcasting bands on which broadcasting channels exist;
a digital conversion module for sampling the received signals from the antenna at sampling frequencies with no aliasing; and
a digital processing module for extracting a signal of desired channel from the output signals of the digital conversion module.

2. The broadcasting receiver as recited in claim 1, wherein the digital conversion module includes:
a Variable Gain Amplifier (VGA) module for amplifying the received signals from the antenna;
an Analog to Digital Conversion (ADC) module for sampling the output signals from the VGA module to convert the signals to digital received digitals; and
a power detection module for adjusting a gain value of the VGA module to fix a power of an output signal from the digital conversion module to a predetermined level.

3. The broadcasting receiver as recited in claim 2, wherein the power detection module detects powers of the digital received signals from the ADC module and adjusting a gain value of the VGA module.

4. The broadcasting receiver as recited in claim 1, wherein the digital conversion module includes:
a VGA module for amplifying the received signals from the antenna;
a power detection module for detecting powers of the output signals from the VGA module to apply the powers to a gain value of the VGA module; and
an ADC module for sampling the output signals from the VGA module to convert the signals to digital received signals.

5. The broadcasting receiver as recited in claim 1, further comprising a filter module for selecting and receiving signals of entire broadcasting bands on which broadcasting channels exist among the signals received through the antenna.

6. The broadcasting receiver as recited in claim 1, wherein the entire broadcasting bands are divided into N subbands, the receiver further comprising:
N filters for selecting and receiving signals of corresponding N subbands out of the received signals from the antenna, respectively; and
a combiner for combining the outputs from the N filters and transferring a combined signal to the VGA module.

7. A broadcasting receiver for receiving signals of entire broadcasting bands composed of N subbands, comprising:
N filters for selecting and receiving signals of the corresponding N subbands, respectively;
N digital conversion submodules for sampling the output signals from each of the N filters at sampling frequencies with no aliasing, respectively; and
a digital processing module for extracting a signal of desired channel among the output signals from the N digital conversion submodules.

8. The broadcasting receiver as recited in claim 7, wherein the digital processing module includes:
an input processor for combining or selecting the output signals from the N digital conversion submodules; and
a digital processor for extracting a signal of desired channel among the signals selected by the input processor.

9. The broadcasting receiver as recited in claim 7, wherein the digital processing module includes N digital processors for extracting signals of desired channels among the output signals from the N digital conversion submodules, respectively.
